(19) United States
(12) Patent Application Publication
(10) Pub. No.: US 2026/0065133 A1
(43) Pub. Date: Mar. 5, 2026

(54) Privacy-preserving access and use of AI models using private data sets

(71) Applicant: Inrupt, Inc., Boston, MA (US)

(72) Inventors: Emmet Townsend, London (GB); Barath Raghavan, Irvine, CA (US)

(21) Appl. No.: 18/822,250

(22) Filed: Sep. 1, 2024

(51) Int. Cl. G06N 20/00

(52) U.S. Cl. CPC G06N 20/00

(57) ABSTRACT

A privacy-preserving method of accessing and using an AI model. That access and use is provided as a service in association with a linked data operating environment. In this environment, applications have secure and permissioned access in an interoperable manner to private data that is stored in one or more online private data stores. The AI model is trained using one or more access sets of private data that are stored in the linked data operating environment. Typically, the model (e.g., a language model, an image-generation (diffusion) model, or the like) is uniquely associated with an entity whose access set of private data is used for model training. To facilitate multi-use training and use, the model comprises a base model that is fine-tuned using the private data access set to generate a fine-tuned model. The fine-tuned model can be further tuned efficiently as data in the underlying access sets changes.

### BACKGROUND OF THE INVENTION

This disclosure relates generally to technologies, products and services for privacy preserving data processing.

The Solid (Linked Data) Ecosystem (“Solid”) is a W3C and industry initiative that provides a set of specification that, together, provide applications with secure and permissioned access to externally stored data in an interoperable way. Solid adds to existing Web standards to provide a space where individuals can maintain their autonomy, control their data and privacy, and choose applications and services to fulfil their needs. To this end, the specifications in the ecosystem describe how Solid servers and clients interoperate by using Web communication protocols, global identifiers, authentication and authorization mechanisms, data formats and shapes, and query interfaces. Participants store their data securely in decentralized data stores called Pods (online data stores), which are akin to personal web servers for data. The notion of “personal” in this context is not limited to a human being, as a Pod may be associated with any person, device, object, organization or thing. Thus, e.g., a Pod may be associated with a human user, a company or government agency, a smart vehicle, an Internet-of-Things (IoT) device, a smart home, or other such construct. When data is stored in a participant's Pod, they control which people and applications can access it. Anyone or anything that accesses data in a Solid Pod can do so in one of two ways: using identity, or using an access grant. Typically, an identity is a unique ID, authenticated by a decentralized extension (e.g., OpenID Connect). An access grant is akin to a key than can be used to open a vault, and a grant can contain any set of claims including an identity. For example, an access grant with a claim providing that a requesting user is employed by the Post Office (even without proof of the requesting user's identity) may be used to gain access to a resource that is only visible to Post Office employees. Solid's access control system uses identity and/or access grants to determine whether a person or application has access to a resource in a Pod. A Solid Server hosts one or more Solid Pods, and each Pod is fully controlled by the Pod Owner, and each Pod's data and access rules are fully distinct from those of other Pods. With Solid's authentication and authorization protocols, the user determines which people and applications can access the user's data. Solid application store and access data in Pods. Within the interoperable Solid ecosystem, different applications can access the same data instead of requiring separate data silos specifically for the applications.

Private data stores, such as Solid, enable users and/or organizations to store data in a structured manner that has several key properties. First, the data can be separated from the application(s) that use the data, enabling the user to control how and when applications use their data. Second, the data hosting is separated from data ownership, enabling the data's owner to migrate the data seamlessly to a new hosting provider and enable applications that operate on that data to continue operation. Third, the identity of users is decoupled from both applications and data, enabling users to select appropriate identity providers who can securely and accurately verify their identity and then use that identity when accessing data stores and using applications. Fourth, the application can request and receive, via an access grant mechanism, secure, fine-grained, temporary access to data of one or more users from one or more data stores, as needed.

In addition to the technologies of secure data stores, new techniques in hardware-based trusted execution of code, called Trusted Execution Environments (TEEs) or secure enclaves, enable a cloud provider or other third party to run code on a user's data, typically on the user's behalf, such that the cloud provider is prevented by the hardware from seeing unencrypted user data or seeing the intermediate or final results of the computation that was performed, despite the code executing at nearly the same speed as it would without a TEE. This enables users to use cloud server resources, including CPUs and/or GPUs, without risk of revealing sensitive data to the cloud provider or other untrusted third parties.

Large Language Models (LLMs), diffusion models, and similar “generative” AI technologies enable the generation of synthetic output based upon training data. The generated output can be used for a wide range of tasks, from completing or writing new natural language text for the user, creating images based upon prompts, summarizing documents, writing poetry and creative works, patching and/or extending images, and much more.

To effectively build such generative AI models, however, one must train the model on a large dataset. The challenge with public data is that it is too generic, filled with errors, bias, and even malicious data, and has questionable legal provenance and ownership. Typically, AI models are trained on carefully-filtered public datasets, as such, they still suffer from the problem of being too generic to most tasks, or being not tailored to the types of content that a specific user or use case needs.

Unfortunately, training an AI model requires direct, unencrypted access to the raw data to be trained on. In the case of sensitive data—which may be sensitive for a wide range of reasons, both personal and commercial—it may not be acceptable or even legal to provide this data to a third party who is training an AI model.

In addition to AI model training, queries of AI models, such as during AI model inference, often involves providing private data as input to the model so that it can provide a response, using the input data as “context.” This too, however, requires the exposure of sensitive/private data to the AI model and thus to whomever is hosting the AI model.

AI models can also be trained multiple times in succession. In this approach, a model is first trained, often on a generic dataset, and then that “pretrained” or base model is then “fine-tuned” with additional data. The fine-tuning process ensures that the model's output, when used for inference, is more closely tailored to the fine-tuned dataset. Fine-tuning enables faster training of a model than training on the combination of the generic and additional datasets, and enables different parties to perform the first training and the fine-tuning.

### SUMMARY OF THE INVENTION

A privacy-preserving method of accessing and using an AI model is provided. That access and use may be provided as a service by a service provider, e.g., the provider of a linked data operating environment, such as Solid. In this type of environment, applications have secure and permissioned access in an interoperable manner to private data that is stored in one or more online private data stores (Pods). In this approach, the AI model is trained using one or more access sets of private data that are otherwise stored in the linked data operating environment. Typically, the model (e.g., a language model, an image-generation (diffusion) model, a multi-modal model, or the like) is uniquely associated with an entity whose access set of private data is used for training the model. The entity is one of: a user, a group of users, an organization, a device or system, or some combination thereof. To facilitate a multi-use training and use, the model comprises a base model that is fine-tuned using the access set of private data to generate a fine-tuned model. Further, a fine-tuned model can be further fine-tuned efficiently as data in the underlying access sets changes.

The foregoing has outlined some of the more pertinent features of the disclosed subject matter. These features should be construed to be merely illustrative. Many other beneficial results can be attained by applying the disclosed subject matter in a different manner or by modifying the subject matter as will be described.

### BRIEF DESCRIPTION OF DRAWINGS

For a more complete understanding of the disclosed subject matter and the advantages thereof, reference is now made to the following descriptions taken in conjunction with the accompanying drawings, in which:

FIG. 1 depicts a representative Solid ecosystem operating environment in which techniques of this disclosure may be practiced;

FIG. 2 depicts a linked data operating environment associated with a model-as-a-service according to this disclosure; and

FIG. 3 depicts an example linked data operating environment wherein an owner of a data store provides secure and permissioned data access to that data store, and including private, fine-grained AI that is owner-controlled with selective model fine tuning according to the techniques of this disclosure.

### DETAILED DESCRIPTION OF THE INVENTION

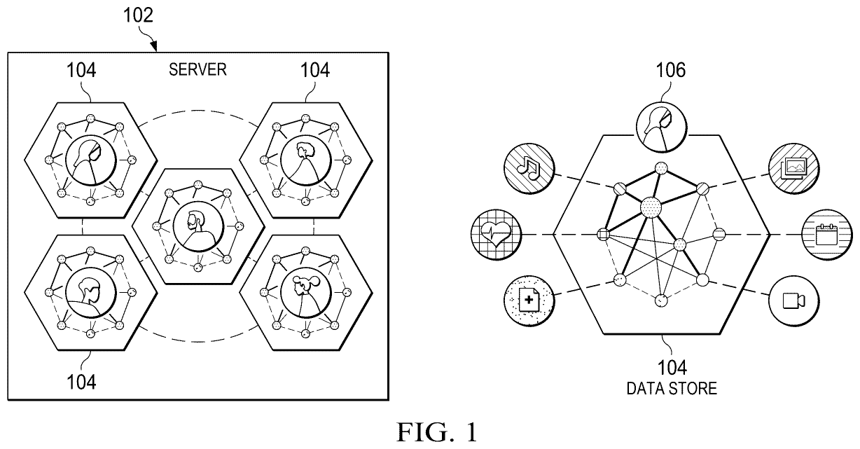

The reader's familiarity with the Solid Ecosystem is presumed. FIG. 1 depicts a Solid operating environment 100 wherein the techniques of this disclosure are implemented. The Solid project is an open, standardized architecture for personal data stores and applications that use those data stores. Personal in this context can mean an individual or an organization or any other entity, including a piece of software. A data store in this context is a repository of data that may or may not be structured (i.e. be tabulated or organized beyond simply raw data). As depicted, the operating environment comprises one or more servers 102 that hosts one or more private data stores 104. Each data store (a Pod) is fully controlled by the owner 106, and each data store's data and access rules are distinct from those of other private data stores in the linked data operating environment. A data store is obtained, e.g., from a data store provider, or a user can self-host the data store. In this ecosystem, data is linked through Identity as opposed through specifics about the data store. As also depicted, a given private data store 104 may store any kind of data.

What keeps data private in a personal data store such as Solid is fine-grained, user-managed access control mechanisms, such as Web Access Control or Access Control Policies as available in Solid. These access control mechanisms, along with Access Grants, enable an application or another user to request data from one or more remote pods. In this architecture, user data is managed by a separate entity from user identity which is managed by a separate entity from applications. This separation between cooperating but mutually non-colluding entities enables a separation of trust and an application of the principle of least privilege to ensure that the storage provider does not know for whom or for what purpose it is storing data (and therefore cannot inadvertently or maliciously access or leak private data). In addition, the application provider can supply software that runs over data that the provider will never have access to. Finally, the identity provider only is responsible for ensuring that a user in the online system is who they claim to be, but has no responsibility for securely storing, accessing, or operating on user data.

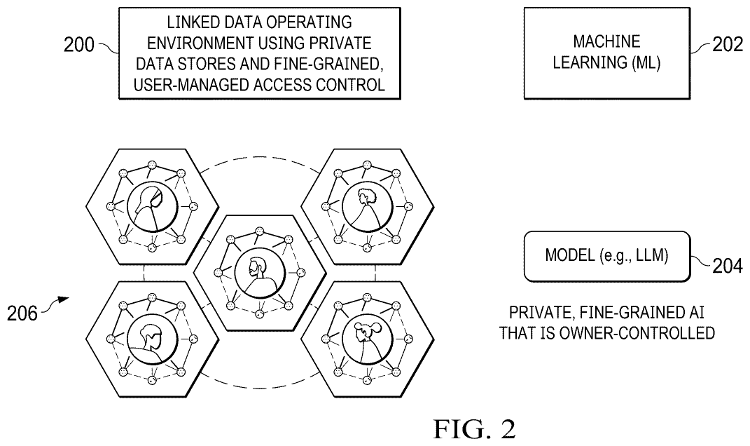

According to this disclosure, and as depicted in FIG. 2, in one embodiment a Solid ecosystem 200 such as described is associated with a machine learning-as-a-service (MLaaS) 202, and the private data in the ecosystem is used to facilitate training of the model 204, typically a generative AI. In particular, this disclosure describes a method and apparatus for using private, secure data stores 206 with AI models (e.g., language models) to improve both the security and relevance of the AI in a wide range of uses. In a representative use case, an entity (e.g., a user, a group of users, an organization, or the like) provides access to selected data resources within a secure data storage system, such as Solid, and then uses that data on AI training and/or inference tasks in such a way as the chain of custody of the data is secured. In addition, the same and different mechanisms can be used to ensure that an AI model that is trained on data from a secure or private data store is itself secured. Although the remainder of this description refers to Solid, this is not intended to be limiting. Generalizing, the techniques herein also apply to other types of private, secure data stores that provide access control and user-and organization-centric protection of data. Further, it is not required that the system only operate in association with private data, as a canonical secure data storage system such as Solid may also store some non-private data.

In a system that incorporates the techniques herein, generative AI is used in various modalities. A first modality is with a custom AI model, trained on the user's data, either in the primary training process or using fine-tuning of a pretrained generic model. In a second modality, a generic AI model is used, and where the model uses the user's data as input (known in AI models as “context”), in which case it is not required for the underlying model to be custom-trained on the user's data. Further, there are many possible uses and applications of private data from a Solid pod or other personal data store and AI models, including but not limited to: as a writing assistant for an individual, where the AI model is trained or fine-tuned on the user's personal, private files so as to more closely align with their writing style or thinking; as a computing assistant for an individual, enabling search, analysis, and manipulation of private data through natural-language instruction of either a generic or fine-tuned AI model; as an agent capable of taking action based upon natural language instructions given by the user, such as but not limited to iterated API or tool-driven interaction with computing systems through a system such as LangChain, where such interaction could leverage the APIs exposed by Solid or a similar data store; and as an organizational agent that provides a large-scale, organizational view across multiple Solid pods that have selected data access granted to the agent, for use in organization level informational purposes (e.g. search and summarization of meetings) or group coordination (e.g. automatically coordinating employees calendars for a meeting). Of course, these use cases are not intended to be limiting.

The following describes a workflow that enables a Solid user to create and use an AI model, e.g., a personalized Large Language Model (LLM). In doing so, and in the example use case of an LLM, a user will be able to gain the benefits of LLMs without exposing their personal data to a third-party LLM provider such as OpenAI. Furthermore, by training a personalized LLM on their data, the user will benefit from the closer fit of the model to their data and use cases.

The nature of the AI (or in the specific use case of generative AI the language model) is not a limitation of this disclosure. For the remainder of this disclosure, and for example purposes only, the AI model is a transformer-based model such as a language model. Generalizing, and by way of additional background, a “language model” is a probabilistic model of sequences. In the case of natural language, language models typically describe the probability of sentences or documents. Being simply probabilistic models, language models can take on many specific incarnations, e.g., column frequencies in multiple sequence alignments, Hidden Markov Models, and deep neural networks. A language model is a type of “generative model,” which is a model of a data distribution, p(X), joint data distribution, p(X, Y), or conditional data distribution, p(X∨Y=y). It is usually framed in contrast to discriminative models that model the probability of the target given an observation, p(Y|X=x).

As used herein, the notion of a “user” or a “Solid user” includes an individual user, a group of users, an organization, a device or system, or some combination thereof.

As depicted in the process flow in FIG. 2, typically the process herein includes a set of operations: data tagging (enabling the user to choose what data goes into the LLM); data formatting (reformatting the user's data so that it can be used in training); LLM training (training the LLM, typically based upon a combination of a general model and the user's own data); and LLM use (presenting a Solid app interface to using the LLM). Each of these operations is now described.

For data tagging, preferably the Solid user is able to specify what data from their Pod should be incorporated into the LLM either in primary training or fine-tuning. As data in the Pod may be in many formats, such as documents containing text (in any common format) or structured communications (such as stored emails with header info), images, video, linked data, etc. the invention may include data adapters, some of which may be AI-enabled, to process the data into a form that can be trained on or otherwise used. Preferably, the user specifies what data is to be incorporated in the model and the format of that data. The system may also be configured to attempt to auto detect data type and structure, possibly using a generic AI model to do so. In a representative but non-limiting embodiment, the data tagging component presents a browser of Pod data in a standard way that allows the user to easily select what data to incorporate, or present the user with an LLM-enabled interface to choose the data he, she or it wants to manipulate. Upon selection, the app requests and receives access to that data.

For data formatting (or more generally pre-processing), and provided that the data the user has selected is not already in a structured format, the format of the data is modified to be incorporated into an LLM training set. This processing may be done in a manner such that the reformatted data is stored safely and securely, possibly in the Solid Pod itself. The specifics of the reformatting needed are context and data specific.

Following tagging and formatting, training is initiated. In particular, the new LLM or other AI model may need to be trained on the reformatted data. The average user, however, is unlikely to have a large enough training set that it can be used in isolation. Thus, and in a preferred embodiment, the LLM us a combination of a baseline, generic model and custom training on the user's data, e.g., through fine-tuning. Without intending to be limiting, this training may be done on cloud infrastructure, as most training requires significant hardware resources. However this training infrastructure can be decoupled from any specific hardware dependencies, so that a user can, at their option, self host the training, gaining additional security and privacy.

Following training, a Solid application that uses the AI model may present a network-accessible graphical user interface (GUI) for interacting with the user's Personalized LLM or a Midjourney-like interface for an image model, or any similar AI model interface. As noted, the location of hosting of the model, either cloud or local, is configurable and may be determined by the user. Also, and depending on storage availability, preferably the model is stored in or in association with a user's Pod.

In a typical but non-limiting embodiment, the infrastructure used to implement the above-described system includes a user's Solid Pod, e.g., as hosted in a remote hosting provider or on a local instance, the user's web browser, running on the user's personal device, an AI training infrastructure, e.g., running either on cloud infrastructure or on a local server, and including one or more GPUs on high-end personal devices or cloud servers, and an AI inference infrastructure, running either on cloud infrastructure or on a local server, also with relatively powerful hardware.

In particular, there are multiple stages at which sensitive data must be handled in the use of AI in the above-described linked data operating environment (Solid). These include data reformatting, AI training, and AI usage. For data reformatting, raw user data must be reformatted and then stored in a format amenable to AI training. This is compatible with Solid Pod data storage, as each Solid resource can be processed and then stored back to the Pod (in a different but parallel location) after reformatting. This processing may be done in a user's browser. The reformatted data must be fed into AI training, which may be self-hosted by the user, or cloud-hosted. Trusted execution environments (also known as secure enclave technologies) may be used as well. For AI usage (inferencing/prediction), typically the entire AI model must be available, e.g., as a whole file that can be loaded into memory. Thus, in practice, the AI model resides on some machine with sufficient hardware resources. This may include self-hosted hardware, or co-locating the AI model usage infrastructure with a Pod provider. A third-party trusted execution environment/secure enclave may also be used.

According to an aspect of this disclosure, multi-use private AI training and use is also enabled. This aspect is now described. By way of background, personal data stores such as Solid enable not just a single use of data for a single user with a single application, but also the ability for one user to provide access to specific pieces of data to many other users in for use with many applications, all in a decentralized environment where none of the parties are controlled by or under the management of a centralized authority. To facilitate a solution of this type, the approach herein provides for baseline model training, and then fine-tuning of that baseline model for individual (or, in appropriated circumstances, shared for collaborative or even public) use. To this end, and as noted, AI models are trained and/or fine-tuned based upon private data stored in a Solid Pod. In one embodiment, the user whose data is being operated over specifies which data and for what other user(s) and application(s) the data should be provided. The data for which a user has given access is referred to herein as access set S. For access set S₀ there can be an AI model trained, called M(S₀), that is, the model trained on S₀. That model, using the techniques described above, typically is protected both during training/fine-tuning and during later inference using the same security mechanisms. The users and/or applications that have access to M(S₀) comprise a run set R(M(S₀)), as these users and/or applications have been given access to run the model for inference purposes.

The security model of single-use model training and inference extends to the multi-use context. Consider many access sets S₀ . . . Sₙ which may or may not have overlapping units of data within them. Each time an existing access set's data changes, its corresponding model can and/or should be updated via additional model training/fine-tuning of the baseline model. Preferably, this mirroring is automatic, managed by the underlying Solid-based system and optionally enabled by the user.

The following describes one approach to efficient multi-use model training and inference. In particular, each fine-tuned model is represented as delta weights on top of a base AI model. Fine tuning can then be done including on top of previous fine tuning, so that the underlying fine tuning does not need to be wasted and only the difference between fine tuning datasets is applied during a subsequent training round. In a large Pod with many different access sets, a change in underlying data may result in not-insignificant computational cost for the AI training/fine-tuning that must be done subsequently to keep the models up to date. An approach to efficient model training/updating in this operating context is now described by the following graph-based algorithm.

In particular, with no access sets present and the first access set S₀ is generated, the first access set is placed at a root of a single tree in a forest of trees. A tree is akin to a hierarchical file system. Incrementally, when an additional access set Sᵢ is generated, all existing trees are searched to find one for which it is a strict superset or subset in terms of the data items in the set. If Sᵢ is a subset, it is made the new root of that tree. Otherwise, the tree is traversed starting at its root until a node is found at which Sᵢ is a subset of that node, in which case that node is made a child of Sᵢ. If no such node is found, Sᵢ is then defined as a leaf. When data changes, models are then updated as follows. In particular, when one or more data items change, models are updated to reflect this fact. To this end, all model nodes that are affected by the change are marked. Then, the algorithm traverses each tree or subtree from marked nodes towards the leaves, re-computing the fine-tuning based upon the parent node's delta weights. This approach re-computes the fewest fine-tuning operations required for updating all the models given the data updates.

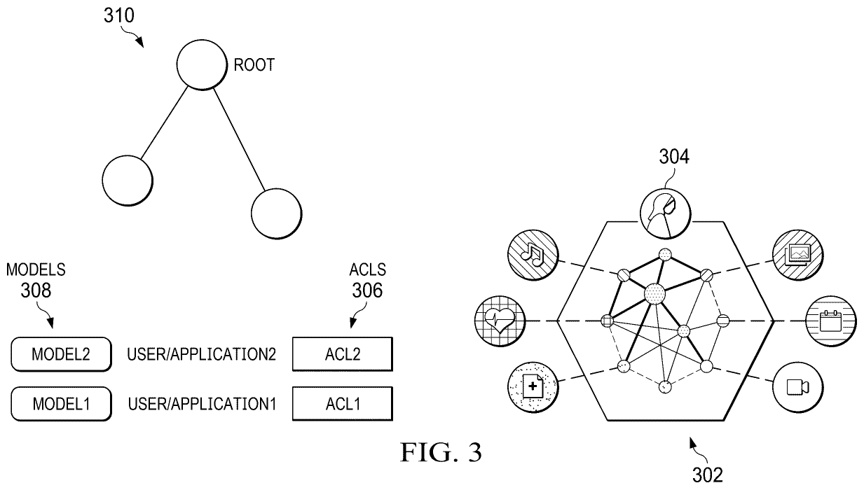

FIG. 3 depicts an example of the above-described update process for a private data store to which multiple users or applications may be associated, and wherein each user/application may have an associated AI model. In this example, which is not intended to be limiting, a linked data operating environment (such as Solid) 300 includes a private data store 302 (e.g., a POD) that has an owner 304. Owner 304 gives access to the data in the private data 302 to users or applications, e.g., via defined access control lists (ACLs) 306. Thus, for example, user/application1 has secure and permissioned access to the owner's data in the private data store via ACL1, user/application2 has secure and permissioned access to that data via ACL2, and so forth.

According to the disclosure herein, it is assumed that there is an AI model1 308 associated with user/application1, an AI model2 associated with user/application2, etc., as well. The owner provides the access grants as needed, including on-demand or in advance, and the models are updated accordingly. This is the baseline use scenario. For improved performance, namely, model fine-tuning, the models are configured as a logical tree of models 310 comprising, for example, a base model X, and one or more additional models Y, Z, etc. In one example embodiment, the base model X might correspond to a user's email data, whereas model Y might correspond to the user's email and photo data. As described above, it is not required to re-train model Y from scratch in the event that such data in the data store (or the associated ACL) is updated; rather, the deltas on top of model X are used for this purpose. Thus, and in this approach, when there is a given update to the ACL or the data in the data store, the logical model tree 310 is traversed (starting from the root), and only the nodes of the tree that need to be re-computed are processed.

As noted above, typically the system leverages one or more off-the-shelf baseline models, which are typically LLMs that have been pre-trained. One or more of such models are then fine-tuned according to the techniques herein to produce the logical model tree, and such fine-tuning may further include the automated updating approach that has been described for performance benefits. As will be appreciated, the techniques leverages the fine-grained access control enabled by the linked data operating environment and applies it to corresponding AI models. This provides for a private, fine-grained AI that is owner-controlled with selective model fine tuning.

Summarizing, and according to this disclosure, a privacy-preserving method of accessing and using an AI model is provided. That access and use may be provided as a service by a service provider, e.g., the provider of a linked data operating environment. In this type of environment, and as has been described, applications have secure and permissioned access in an interoperable manner to private data that is stored in one or more online private data stores. The AI model is trained using one or more access sets of private data that are otherwise stored in the linked data operating environment. Typically, the model (e.g., a language model, an image-generation (diffusion) model, a multi-modal model, or the like) is uniquely associated with an entity whose access set of private data is used for training the model. The entity is one of: a user, a group of users, an organization, a device or system, or some combination thereof. To facilitate a multi-use training and use, the model comprises a base model that is fine-tuned using the access set of private data to generate a fine-tuned model.

Further, a fine-tuned model can be further fine-tuned efficiently as data in the underlying access sets changes. In this manner, the approach enables private data sets to be used to create view-specific models (namely, the fine-tuned models atop a baseline model), and such models are then accessed and used natively within the secure operating environment.

### Enabling Technologies

As noted above, the techniques herein are carried out in association with a Solid ecosystem. According to the Solid Protocol, a data pod is a place for storing resources, with mechanisms for controlling who can access what. A Solid application (app) is an application that reads or writes data from one or more storages. A Uniform Resource Identifier (URI) provides the means for identifying resources. A resource is the target of an HTTP request identified by a URI. A container resource is a hierarchical collection of resources that contains other resources, including containers. A root container is a container resource that is at the highest level of the collection hierarchy. Resource metadata encompasses data about resources described by means of RDF statements. An agent is a person, social entity, or software identified by a URI; e.g., a WebID denotes an agent. An owner is a person or a social entity that is considered to have the rights and responsibilities of a data storage. An owner is identified by a URI, and implicitly has control over all data in a storage. An owner is first set at storage provisioning time and can be changed. An origin indicates where an HTTP request originates from. A read operation entails that information about a resource's existence or its description can be known. A write operation entails that information about resources can be created or removed. An append operation entails that information can be added but not removed.

Generalizing, one or more functions of the above-described system may be implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). Example SaaS solutions may include AI-as-a-Service, ML-as-a-Service, and the like.

The platform may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

More generally, the Solid Ecosystem comprises a set of one or more computing-related entities (systems, machines, processes, programs, libraries, functions, or the like) that together facilitate or provide the functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the system have been described separately, one of ordinary skill will appreciate that some of the functions may be combined or shared in given instructions, program sequences, code portions, and the like.

Any described commercial products, systems and services are provided for illustrative purposes only and are not intended to limit the scope of this disclosure.

The techniques herein provide for improvements to technology or technical field, as well as improvements to various technologies, all as described.

Having described the subject matter, what is claimed is as follows.

1. A privacy-preserving method of accessing and using a model as a service, comprising:
associating a linked data operating environment with the service, wherein applications in the linked data operating environment have secure and permissioned access in an interoperable manner to private data that is stored in one or more online private data stores;
training the model using one or more access sets of private data, wherein a given access set of private data is defined in response to a fine-grained, user-managed access control mechanism; and
following training, applying the trained model to an input data set.

2. The method as described in claim 1, wherein the model as a service is deployed as one of: a language model, and an image model, a multi-model model, and combinations thereof, and wherein the linked data operating environment is Solid.

3. The method as described in claim 2, wherein the model is uniquely associated with an entity whose access set of private data is utilized for training the model.

4. The method as described in claim 3, wherein the entity is one of: a user, a group of users, an organization, a device or system, and combinations thereof.

5. The method as described in claim 3 wherein the model comprises a base model that is fine-tuned using the access set of private data to generate a fine-tuned model that enables view-specific model inferencing.

6. The method as described in claim 5 wherein the base model is a general purpose generative AI model.

7. The method as described in claim 1 wherein the access sets of private data comprise a first access set of private data that is associated with a first entity having a first private data store and a second access set of private data that is associated with a second entity having a second private data store.

8. The method as described in claim 1 wherein the model is trained under control of a given application in the linked data operating environment.

9. The method as described in claim 1, wherein the access set of private data is used as one of: training data for the model, a contextual input to the model, and combinations thereof.

10. The method as described in claim 1, wherein the model as a service is hosted in the linked data operating environment.

11. The method as described in claim 1, wherein the model is trained or applied in or in association with a secure enclave.

12. The method as described in claim 1, further including pre-processing the access set of private data to generate training data for the model.

13. The method as described in claim 11, further including storing the generated training data in a private data store of the linked data operating environment.

14. The method as described in claim 1, further including exposing the model via an application interface in the linked data operating environment.

15. The method as described in claim 1, further including updating the trained model in response to an update of the access set of private data.

16. The method as described in claim 3, wherein, for each of one or more access sets of private data, the fine-tuned model comprises a set of differences associated with the base model.

17. The method as described in claim 16, wherein the base model and the fine-tuned models associated with the access sets of private data are organized as a hierarchy comprising a root node, and a set of one or more trees.

18. The method as described in claim 17, further including updating a given fine-tuned model in the hierarchy while leaving one or more other fine-tuned models unchanged responsive to receipt of a change in the access set of private data used to create the given fine-tuned model.

19. The method as described in claim 1, wherein at least some access sets of private data have common private data.
